(19) United States
(12) Patent Application Publication
(10) Pub. No.: US 2014/0037829 A1
(43) Pub. Date: Feb. 6, 2014

(54) DRY AGING PROCESSES FOR MEAT

(71) Applicant: Stanley Lobel, Purchase, NY (US)

(72) Inventor: Stanley Lobel, Purchase, NY (US)

(21) Appl. No.: 13/776,659

(22) Filed: Feb. 25, 2013

Related U.S. Application Data
(60) Provisional application No. 61/603,332, filed on Feb. 26, 2012.
(60) Provisional application No. 61/663,497, filed on Jun. 22, 2012.
(60) Provisional application No. 61/664,122, filed on Jun. 25, 2012.

(51) Int. Cl. A23B 4/03

(52) U.S. Cl. CPC A23B 4/03
USPC 426/644; 426/443; 426/645

(57) ABSTRACT

A method of dry aging meat includes covering an exposed portion of the meat with at least one layer of fat and/or bone that is separate from the meat and maintaining the layer of fat and/or bone on the exposed portion of meat for sufficient time and at a temperature, humidity, and airflow to permit the meat to dry age. A primal cut of meat or a sub-primal cut of meat may be dry aged. Boneless or bone-in meat may be dry aged.

### CROSS-REFERENCE TO RELATED APPLICATIONS

The benefits of Provisional Application No. 61/603,332 filed Feb. 26, 2012, Provisional Application No. 61/663,497 filed Jun. 22, 2012, and Provisional Application No. 61/664,122 filed Jun. 25, 2012, each entitled “Dry Aging Processes for Meat,” are claimed under 35 U.S.C. § 119(e), and the entire contents of these provisional applications are expressly incorporated herein by reference thereto.

### FIELD OF THE INVENTION

The invention relates to aging processes for meat products. More particularly, the invention relates to aging processes for bone-in and boneless meat.

### BACKGROUND OF THE INVENTION

Following slaughter of an animal, its meat can be aged—a process sometimes alternatively referred to as conditioned or ripened—through refrigeration typically at temperatures just above freezing (e.g., 34-36° F.). The timeframe during which the aging occurs can vary but may occur over many weeks. In the aging process, a natural breakdown of the meat occurs during which the muscle at first shortens and stiffens but then becomes more tender over time. Chemical changes occurring in the muscle and fat during aging produce a meat that is desired because of the flavor, aroma, and tenderness that develop.

Wet aging is the fastest and least expensive aging process. By vacuum packing meat in a plastic layer, the meat is sealed so that moisture generally cannot escape from within and the meat is surrounded by and absorbs its juices. Storing meat in this manner, without an ability to breathe through the plastic barrier, produces a distinctive taste.

In addition, because of the ease of achieving wet aging, and the speed in which it occurs, wet aging is by far the most popular approach.

On the other hand, dry aging is a more time consuming process in which meat is left exposed in a controlled, cold environment and allowed to breathe. Because of the exposure to air, an outer portion of the meat turns and that crusty layer must be trimmed and discarded. Over time, the meat loses weight and shrinks. Helping to minimize the eventual loss of meat to spoilage, regions of fat and bone on carcasses, primals, and subprimals help protect meat from the exposure in the air. In fact, meat that naturally has bone protecting one surface often has fat naturally located and protecting another surface. With such a high degree of surface area protected naturally, such meat is well-suited for dry aging. Certain cuts of meat, however, lack natural layers of fat or bone to aid in protecting the meat surface during dry aging. Those cuts are traditionally not dry aged due to the unacceptable percentage of meat that would need to be discarded following the aging process. Nevertheless, this process which typically is undertaken over one to five weeks produces highly sought after distinctive flavor and tenderness beyond that achievable with the wet aging process.

In addition, sometimes a hybrid approach is chosen to aging. For example, meat may be dry aged for several weeks and subsequently wet aged.

It is known that the environment in which the aging process occurs is important. Not only must the temperature be low as described above, but the relative humidity also plays a role. In particular, a humid environment is advantageous and a relative humidity of 85-90% is typical. Moreover, air flow is important as well. The exposed surface of the meat typically is subject to an airflow of 15-20 linear ft./min.

In the United States, the organized grading of cattle and beef has become particularly important in the promotion and marketing of quality products. Administered by the United States Department of Agriculture, the grading system is used to assign a distinct level of quality to cattle carcasses.

Carcass beef grades assigned by the United States Department of Agriculture include a “yield grade” and a “quality grade.” The yield grade, denoted by the numbers 1 through 5, generally refers to the degree of cutability of the carcass and serves as an indicator of the amount of closely trimmed (½ inch fat or less), boneless retail cuts expected to be derived from the major wholesale cuts of the carcass. “Yield Grade 1” represents the highest degree of curability. The quality grade, on the other hand, separately indicates the palatability of the lean. Carcasses of steers and heifers may be graded as Prime, Choice, Select, Standard, Commercial, Utility, Cutter, and Canner, in descending order of quality; carcasses of cows may receive any of these grades except Prime. Bullock carcasses may be graded as Prime, Choice, Select, Standard, and Utility. Steers are considered male bovines castrated when young and which have not begun to develop the secondary physical characteristics of bulls, while heifers are considered young, such as less than 3 year old immature female bovines that have not developed the physical characteristics typical of cows, e.g., have not borne a calf. Cows are considered female bovines that have developed through reproduction or with age, the physical characteristics typical of mature females, and bullocks are considered young, such as under approximately 24 months of age, male bovines that have developed or begun to develop the secondary physical characteristics of bulls.

The highest quality grade, USDA Prime, is reserved for beef with abundant marbling (defined as flecks of fat within the lean muscle), thus providing a juicy and flavorful meat that also is tender. USDA Prime, for example, may have more than 8% intramuscular fat. Only a small percent of all graded carcass beef qualifies as USDA Prime. As would be expected, Prime beef is favored by hotels and restaurants, is a successful commercial export product from the United States, and also is available through retail sales to discriminating consumers. Because it represents the highest quality, beef certified as USDA Prime commands the highest prices in the market.

The carcass typically refers to both sides of the animal, whereas a side refers to half of the carcass including both a forequarter/frontquarter and a hindquarter. From the standpoint of profitability the hindquarter cuts of the carcass, which represent about half of a side of a beef carcass, traditionally have been greatest in demand. In particular, the hindquarter includes the full loin with the short loin and sirloin, the round, flank, and kidney knob. Thus, the hindquarter is the source of the well-known beef cuts including the top loin steak, T-bone steak, porterhouse steak, tenderloin roast or steak (such as chateaubriand or filet mignon), top sirloin steak, sirloin steak, tenderloin roast or steak, beef tri-tip, round steak, top round roast or steak, and rump roasts.

The forequarter/frontquarter, which represents the other half of a side of a beef carcass, includes the chuck, rib, plate, brisket and shank. Products typically produced from the forequarter/frontquarter include cuts such as the rib roast or steak, rib eye roast or steak, back ribs, skirt steak, whole brisket, shoulder roast or steak, or chuck roast or steak.

International trade in beef products is a very significant industry. There is great demand for exports of beef from the United States, for example, to many countries that recognize the high quality of the beef—especially USDA Prime beef—and also have high consumer demand either due to the desire for high quality or due to unavailability of sufficient product produced domestically.

There also is a high demand for dry aged meat, both domestically (e.g., in the United States) and internationally. Yet for exports, restrictions exist that place limitations on the ability to ship bone-in meat. Although exports and subsequent import of boneless meat are permitted with respect to many countries, bone-in meat is treated differently. Thus, for certain meat that is boneless, dry aged product is not available because that process has been commercialized with respect to bone-in meat (as explained above, layers of fat and bone aid in protecting the meat during dry aging, such that an unacceptable percentage of meat need not be discarded due to surface rotting during the aging process).

Although dry aged meat is highly sought after, many cuts simply are not processed and available as dry aged meat. The difficulty with dry aging boneless meat is that with such substantial portions of the meat directly exposed to the air, a significant portion of the meat spoils and thus must be trimmed and discarded. Such an inefficient use of the meat is not desirable, especially for valuable beef cuts like whole filets. Thus, there exists a need for methods of dry aging that more efficiently produce dry aged meat. In particular, there exists a need for methods of dry aging boneless meat.

Separately, there exists a need for using trimmings from meat, especially fat, that are otherwise discarded without being used. While fat is occasionally used to help meat retain its moisture during cooking and to protect the surface of the meat from burning and becoming tough during cooking, disclosed herein is a different use for fat in connection with the aging process in which moisture is not retained but instead lost from the meat.

### SUMMARY OF THE INVENTION

In one embodiment, a method of dry aging a primal cut of meat includes: covering an exposed meat portion of the primal cut of meat with at least one layer of fat that is separate from the primal cut; and maintaining the layer of fat on the exposed meat portion for sufficient time and at a temperature, humidity, and airflow to permit the primal cut to dry age. The primal cut may be boneless or may not be boneless. The layer of fat may be between ¼ inch and 2 inches in thickness. The meat may be bovine, or may be selected from the group consisting of bovine, lamb, pork, veal, and poultry. The time may be from two weeks to six weeks, the temperature may be from 34° F. to 36° F., the humidity may be from 85% to 90% relative humidity, and/or the airflow may be from 15 linear feet per minute to 20 linear feet per minute. A primal cut of meat may be dry aged according to this method.

In another embodiment, a method of dry aging a sub-primal cut of meat includes: covering an exposed meat portion of the sub-primal cut of meat with at least one layer of fat that is separate from the sub-primal cut; and maintaining the layer of fat on the exposed meat portion for sufficient time and at a temperature, humidity, and airflow to permit the sub-primal cut to dry age. A sub-primal cut of meat may be dry aged according to this method.

In yet another embodiment, a method of dry aging a filet mignon includes: covering an exposed meat portion of the filet mignon with at least one layer of fat that is separate from the filet mignon; and maintaining the at least one layer of fat on the exposed meat portion for sufficient time and at a temperature, humidity, and airflow to permit the filet mignon to dry age. The at least one layer of fat may be wrapped around the filet mignon. In some embodiments, the at least one layer of fat substantially covers all exposed meat surfaces of the filet mignon. Filet mignon may be dry aged according to this method.

In a further embodiment, a method of dry aging boneless meat includes: covering an exposed meat portion of the boneless meat with at least one layer of fat that is separate from the boneless meat; and maintaining the at least one layer of fat on the exposed meat portion for sufficient time and at a temperature, humidity, and airflow to permit the boneless meat to dry age. The at least one layer of fat may be wrapped around the boneless meat. In some embodiments, the at least one layer of fat substantially covers all exposed meat surfaces the boneless meat. The method may further include covering another exposed meat portion of the boneless meat with at least one bone that is separate from the boneless meat. Boneless meat may be dry aged according to this method.

Still further, a method of dry aging meat may include: covering an exposed portion of the meat with at least one layer of fat that is separate from the meat; and maintaining the layer of fat on the exposed portion of meat for sufficient time and at a temperature, humidity, and airflow to permit the meat to dry age. Meat may be dry aged according to this method.

### DETAILED DESCRIPTION OF THE PREFERRED EMBODIMENTS

In an exemplary, preferred embodiment, a boneless primal cut of meat is dry aged by exposing the meat to air conditions, including temperature, humidity, and airflow, conducive to safely and efficiently dry aging the meat over a period of up to six weeks. In order to decrease the amount of surface rotting that occurs during the course of the dry aging, at least one layer of fat is added to at least one exposed surface portion of the meat in order to cover it from direct exposure to the air conditions. In the exemplary embodiment, the layer of fat is derived from the same kind of animal as the meat. For example, if the meat is bovine, then preferably the layer of fat is bovine as well.

Typically, a filet mignon is a boneless cut of beef. In order to dry age the filet, while limiting the amount of surface rotting that would otherwise occur without protecting the surface, at least one layer of fat is added to at least one exposed surface portion of the filet in order to cover it from direct exposure to the air conditions as mentioned above. The layer of fat may be formed of unitary construction, or it may be formed of more than one piece of fat. The filet may be of USDA Prime grade, for example. Once the desired length of time for aging has elapsed, the layer of fat is removed from the meat and may be discarded or in some instances reused as a surface covering for another piece of meat to be dry aged.

In one embodiment, a Porterhouse steak may be cut in half through the bone to produce a bone-in strip steak and a bone-in filet mignon. Aging of the bone-in filet may be achieved in part because the bone may protect a first side of the filet. In addition, the aging process is benefited by protecting a second surface of the filet by adding a layer of fat on top of it. Again, once the aging process has run its desired course, the layer of fat may be removed and discarded or optionally reused on another piece of meat.

For a cut of meat such as a boneless filet mignon, prior to the method disclosed herein, the meat could not be efficiently dry aged because of the extent of spoilage that would occur on the surface of the meat. Because a boneless filet has neither a bone nor fat covering substantially any surface, the extent of rotting and thus loss of edible meat becomes significant. In an exemplary embodiment according to the disclosed method, however, a boneless filet may be covered on at least a portion of the surface thereof with an added layer of fat while the filet is maintained in the air conditions as mentioned above. In another exemplary embodiment, the filet may be wrapped in a layer of fat to substantially cover all exposed meat surfaces during the aging process.

Preferably, the layer of fat has a thickness between ¼ inch and 2 inches. In the preferred exemplary embodiment, a fat covering of ¼ inch is used.

Other exemplary cuts of beef besides filet mignon and Porterhouse that are suitable for the methods disclosed herein include but are not limited to boneless and/or bone-in New York strip loin, rib eye, T-bone, top sirloin, and flat iron. In some embodiments, entire primal cuts may be dry aged. In terms of so-called American primal cuts of meat from bovines (including cows, bulls, heifers and steers), as mentioned earlier, the chuck, rib, brisket, plate, shank, loin, round, and flank may be dry aged according to the methods disclosed herein. In addition, sub-primal cuts such as those from the loin (the short loin, sirloin, and tenderloin) may be dry aged according the methods disclosed herein. As for the so-called United Kingdom primal cuts of meat from bovines, the neck and clod, chuck and blades, silver loin, rump, silverside, topside, thick rib, thin rib, brisket, shin and leg, flank, thick flank, and feather blade each may be dry aged according the methods disclosed herein. As for the so-called Dutch primal cuts, the neck, rib, sirloin, tenderloin, top sirloin, round, flank, chuck, brisket, and shankle each may be dry aged according the methods disclosed herein.

In addition, while not traditionally used in American cuisine, both the tail and the tongue also may be dry aged according the methods disclosed herein.

In some embodiments, meat is dry aged by hanging in the air conditions described herein. In such a case, the layer(s) of fat may be added to the meat to protect its surface(s) during the aging process and maintained in place for example using twine to releasably couple the fat layer(s) to the meat. In other embodiments, meat is dry aged by shelf-storage, for example.

Advantageously, the layers of fat used as described in the aging methods herein largely would otherwise be discarded when removed from the animal carcass.

In some embodiments, meat may be shipped with at least one added layer of fat and/or bone. It also is possible to ship meat only, with the fat and/or bone added when a dry aging process is done at the shipment destination. The fat and/or bone added at the shipment destination may not have originated from the same carcass as the meat. In some embodiments, fat and/or bone obtained at a shipment destination from one or more carcasses may be used with the meat when it arrives in order to accomplish the dry aging process. In one exemplary embodiment, meat from an animal slaughtered on the western United States may be received at a destination on the eastern United States and then dry aged by contacting one or more portions thereof with fat and/or bone for example from one or more carcasses not originating on the west coast. In another exemplary embodiment, meat from an animal slaughtered in the United States may be received at a destination in Asia or Europe and then dry aged by contacting one or more portions thereof with fat and/or bone for example from one or more carcasses not originating in the United States (but instead, for example, originating in Asia or Europe). Alternatively, meat and fat and/or bone may be shipped together but not yet in contact with one another, and at least one layer of fat may then be placed on the meat after arrival of the shipment. By shipping in cryovac, it is possible for meat to be dry aged after receipt by a buyer.

In some exemplary embodiments, fat and/or bone may be chemically coupled to meat for example with edible glue to ensure contact during the aging process. In alternate exemplary embodiments, to ensure contact during the aging process, fat and/or bone may be mechanically coupled to meat for example using one or more pins, staples, or clips.

The methods disclosed herein apply, for example, to primal cuts of meat, sub-primal cuts of meat, filet mignon, boneless meat, and bone-in meat. In an exemplary embodiment, a 20-30 pound piece of beef such as a whole boneless chuck or a whole boneless loin may be aged according to the method disclosed herein.

In contrast to the prior art in which fat is separately added to meat so that the meat retains its moisture during cooking, and so that the surface of the meat is not burned during cooking, the dry aging processes described herein prolong the life of the meat while at the same time permitting the loss of moisture that accompanies dry aging. Advantageously and unexpectedly, adding one or more layers of fat to the surface of meat to protect the surface from degradation permits an improved dry aging process.

Although dry aging of bovine meat is described above, other types of meat may be dry aged according to the methods disclosed herein including lamb, pork, veal, and poultry. Thus, the method may be applied, for example, to the primal cuts of a pig. While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A method of dry aging a primal cut of meat comprising:
covering an exposed meat portion of the primal cut of meat with at least one layer of fat that is separate from the primal cut;
maintaining the layer of fat on the exposed meat portion for sufficient time and at a temperature, humidity, and airflow to permit the primal cut to dry age.

2. The method of claim 1, wherein the primal cut is boneless.

3. The method of claim 1, wherein the primal cut is not boneless.

4. The method of claim 1, wherein the layer of fat is between ¼ inch and 2 inches in thickness.

5. The method of claim 1, wherein the meat is bovine.

6. The method of claim 1, wherein the meat is selected from the group consisting of bovine, lamb, pork, veal, and poultry.

7. The method of claim 1, wherein the time is from two weeks to six weeks.

8. The method of claim 1, wherein the temperature is from 34° F. to 36° F.

9. The method of claim 1, wherein the humidity is from 85% to 90% relative humidity.

10. The method of claim 1, wherein the airflow is from 15 linear feet per minute to 20 linear feet per minute.

11. A primal cut of meat dry aged according to the method of claim 1.

12. A method of dry aging a sub-primal cut of meat comprising:
covering an exposed meat portion of the sub-primal cut of meat with at least one layer of fat that is separate from the sub-primal cut;
maintaining the layer of fat on the exposed meat portion for sufficient time and at a temperature, humidity, and airflow to permit the sub-primal cut to dry age.

13. A sub-primal cut of meat dry aged according to the method of claim 12.

14. A method of dry aging a filet mignon comprising:
covering an exposed meat portion of the filet mignon with at least one layer of fat that is separate from the filet mignon;
maintaining the at least one layer of fat on the exposed meat portion for sufficient time and at a temperature, humidity, and airflow to permit the filet mignon to dry age.

15. The method of claim 14, wherein the at least one layer of fat is wrapped around the filet mignon.

16. The method of claim 14, wherein the at least one layer of fat substantially covers all exposed meat surfaces of the filet mignon.

17. Filet mignon dry aged according to the method of claim 14.

18. A method of dry aging boneless meat comprising:
covering an exposed meat portion of the boneless meat with at least one layer of fat that is separate from the boneless meat;
maintaining the at least one layer of fat on the exposed meat portion for sufficient time and at a temperature, humidity, and airflow to permit the boneless meat to dry age.

19. The method of claim 18, wherein the at least one layer of fat is wrapped around the boneless meat.

20. The method of claim 18, wherein the at least one layer of fat substantially covers all exposed meat surfaces of the boneless meat.

21. The method of claim 18, wherein the at least one layer of fat is coupled to the exposed meat portion with edible glue.

22. The method of claim 18, further comprising:
covering another exposed meat portion of the boneless meat with at least one bone that is separate from the boneless meat.

23. The method of claim 22, further comprising:
applying edible glue to couple the boneless meat portion to at least one selected from the group consisting of the at least one layer of fat and the at least one bone.

24. Boneless meat dry aged according to the method of claim 18.

25. A method of dry aging meat comprising:
covering an exposed portion of the meat with at least one layer of fat that is separate from the meat;
maintaining the layer of fat on the exposed portion of meat for sufficient time and at a temperature, humidity, and airflow to permit the meat to dry age.

26. Meat dry aged according to the method of claim 25.
